(19) United States
(12) Patent Application Publication
(10) Pub. No.: US 2021/0119927 A1
(43) Pub. Date: Apr. 22, 2021

(54) SERVICE TRAFFIC DISTRIBUTION BASED ON TIME WINDOW

(71) Applicant: BEIJING SANKUAI ONLINE TECHNOLOGY CO., LTD, Beijing (CN)

(72) Inventors: Yifan YANG, Beijing (CN); Fan BAI, Beijing (CN)

(21) Appl. No.: 17/047,371

(22) PCT Filed: Dec. 19, 2018
(86) PCT No.: PCT/CN2018/121940

§ 371 Date: Oct. 13, 2020

(30) Foreign Application Priority Data
Apr. 11, 2018 (CN) 201810322980.5

(51) Int. Cl. H04L 12/841; H04L 12/927

(52) U.S. Cl. CPC H04L 47/28; H04L 47/808

(57) ABSTRACT

A service traffic distribution method based on a time window is provided. The method includes: generating a time window based on a reference rule; determining, according to an operation behavior performed by a user on a client in the generated time window, service traffic to be distributed; and distributing the determined service traffic.

### CROSS REFERENCE TO RELATED APPLICATIONS

This application is a national phase of the international application No. PCT/CN2018/121940, filed on Dec. 19, 2018 and entitled “SERVICE TRAFFIC DISTRIBUTION BASED ON TIME WINDOW”. This international application claims the priority to the Chinese Application No. 201810322980.5, filed on Apr. 11, 2018 and entitled “SERVICE TRAFFIC DISTRIBUTION METHOD AND APPARATUS BASED ON TIME WINDOW, AND ELECTRONIC DEVICE.” Both applications are incorporated herein by reference in its entirety.

### TECHNICAL FIELD

Embodiments of the present disclosure relate to the field of computer technologies, and in particular, to service traffic distribution based on a time window.

### BACKGROUND

Real-time user behavior-based operation is to respond to a real-time user behavior stream collected by a client. For example, after a user completes an action in an application (app), a marketing action corresponding to the action is performed in real time. With increasingly abundant service types of Internet enterprises, a user can browse, purchase and use a plurality of services in an application, to express a mixed intention. For example, a user may purchase food, book a hotel room or buy a movie ticket on a client of a Meituan app.

### SUMMARY

The present disclosure provides a service traffic distribution method based on a time window.

In an aspect, embodiments of the present disclosure provide a service traffic distribution method based on a time window, including: generating a time window based on a reference rule; determining, according to an operation behavior performed by a user on a client in the generated time window, service traffic to be distributed; and distributing the determined service traffic.

In an aspect, embodiments of the present disclosure further disclose an electronic device, including a memory, a processor, and a computer program that is stored in the memory and is executable by the processor, the processor, when executing the computer program, implementing the following service traffic distribution method based on a time window: generating a time window based on a reference rule; determining, according to an operation behavior performed by a user on a client in the generated time window, service traffic to be distributed; and distributing the determined service traffic.

In an aspect, embodiments of the present disclosure provide a non-transitory computer-readable storage medium, storing a computer program, the program, when executed by a processor, implementing the following service traffic distribution method based on a time window: generating a time window based on a reference rule; determining, according to an operation behavior performed by a user on a client in the generated time window, service traffic to be distributed; and distributing the determined service traffic.

### BRIEF DESCRIPTION OF THE DRAWINGS

To describe the technical solutions of the embodiments of the present disclosure more clearly, the following briefly describes the accompanying drawings required for describing the embodiments or the related art. Apparently, the accompanying drawings in the following description show only some embodiments of the present disclosure, and a person of ordinary skill in the art may still derive other drawings from the accompanying drawings without creative efforts.

FIG. 1 is a flowchart of a service traffic distribution method according to an embodiment of the present disclosure.

FIG. 2 is a schematic diagram of a time window in the service traffic distribution method according to an embodiment of the present disclosure.

FIG. 3 is a schematic diagram of another time window in the service traffic distribution method according to an embodiment of the present disclosure.

FIG. 4 is a first schematic structural diagram of a service traffic distribution apparatus according to an embodiment of the present disclosure.

FIG. 5 is a second schematic structural diagram of the service traffic distribution apparatus according to an embodiment of the present disclosure.

### DETAILED DESCRIPTION

The following clearly and comprehensively describes the technical solutions in the embodiments of the present disclosure with reference to the accompanying drawings in the embodiments of the present disclosure. Apparently, the described embodiments are some embodiments of the present disclosure rather than all of the embodiments. All other embodiments obtained by a person of ordinary skill in the art based on the embodiments of the present disclosure without creative efforts shall fall within the protection scope of the present disclosure.

During real-time user behavior-based operation, when a user expresses a mixed intention in an app, each service module intends to extend marketing to the user. In a case that the frequency of using a user reach channel is limited, how to distribute behaviors of the user to the most suitable service module to improve operation efficiency of the service traffic is a problem to be resolved. Currently, each service module operates independently, and preemptive service traffic distribution is used. That is, a service module that is first triggered by the user has a priority to use the user reach channel. This does not consider the overall service traffic utilization efficiency of the app, resulting in low service traffic distribution efficiency.

This embodiment discloses a service traffic distribution method. As shown in FIG. 1, the method includes: step 110 and step 120.

Step 110. Generate a time window based on a reference rule.

The time window in this embodiment of the present disclosure is a specified time period. In this embodiment of the present disclosure, the time window is used as a time scale for generating an arbitration point, and by obtaining a context of a client using process of a user in the time window, inconsistency of intention recognition on the time scale can be eliminated. The arbitration point is a time point used for determining a user intention, and the user intention is determined based on a mixed intention expressed by the user in a corresponding time window.

The reference rule may be set according to actual requirements. The following describes two setting manners provided in this embodiment of the present disclosure.

In the first manner, the reference rule may be using one running period of the client as a time window (for ease of distinguishing, referred to as a first time window). In this case, the generating a time window based on a reference rule may include: generating a first time window when the client exits, where the first time window is a time period from start to exit of the client.

For example, after the client starts at 18:00, as the user continuously uses the client, a running time of the client increases. If the client runs for 5 minutes, and exits at 18:05, the first time window is generated when the client exits. In this case, the first time window is the time period from start to exit of the client, that is, a time period from 18:00 to 18:05.

The first time window may be generated immediately upon detecting that the client exits. Alternatively, the first time window is not generated immediately when the client exits; instead, the timing on the exit timing starts. When duration of the exit timing reaches reference duration and the client does not restart, the first time window is generated. Exemplarily, when the user leaves an app client, the time window is not generated immediately; instead, an exit delay window is created to time duration in which the user is not in the app. If the user does not re-enter the client within a reference time, it is determined that the user exits the client, and the first time window is generated. The first time window is the time period from start to exit of the client. The intention of the user may be better determined based on the generated first time window.

In a second manner, the reference rule may be periodically generating a time window (for ease of distinguishing, referred to as a second time window) when the client runs. A start moment of the second time window is a start moment of the period, and an end moment of the second time window is an end moment of the period.

A process of generating the second time window is described below by using an example in which the second time window is generated with 30 seconds as a period when the client runs. For example, after the client starts at 18:00:00, as the user continuously uses the client, the running time of the client increases, and after the client runs for 30 seconds, the second time window is generated. A time period corresponding to the second time window is from a start moment 18:00:00 of the first period to an end moment of 18:00:30 of the first period. As the user continuously uses the client, the running time of the client continuously increases, and after the client continuously runs for another 30 seconds, another second time window is generated. A time period corresponding to the second time window is from a start moment 18:00:30 of the second period to an end moment of 18:01:00 of the second period.

In some embodiments, a current period may be further adjusted according to at least one of a user behavior habit and a service type performed by the user in the client. For example, according to historical statistics information of users, for a user who has a relatively long decision-making period, a longer period is set for the user, for example, 1 minute. Alternatively, a current period is adjusted according to characteristics of a commodity category currently viewed by the user in the client, and the like. For example, a browse for a wedding category takes a longer time than a browse for a takeaway category. In this case, when the user browses commodities of the wedding category, a longer period is set, for example, 5 minutes. When the user switches to browse a food category, a shorter period is set, for example, 30 seconds. By dynamically adjusting the current period, the intention of the user obtained in a decision-making period is as complete as possible, and the number of decision-makings may be reduced, thereby improving service traffic distribution efficiency.

The foregoing separately describes the two manners for generating the time window provided in this embodiment of this application. It should be noted that, exemplarily, the two manners for generating the time window are not mutually exclusive. In some embodiments, when the client runs, the second time window may be periodically generated according to the second manner, and when the client exits, a first time window is generated according to the first manner.

Step 120. Determine, according to an operation behavior performed by a user on a client in the generated time window, service traffic to be distributed, and distribute the determined service traffic.

An implementation of “obtaining an operation behavior performed by the user on the client in the generated time window” is first described.

Exemplarily, real-time data of operations performed by the user on the client may be obtained by setting monitoring items in client software of an app. After the monitoring items are triggered, the triggered monitoring items are reported to a back-end server, and the monitoring items reported to the server form a real-time data stream of the user. For example, when the user opens the client of the app, that is, the client starts, a monitoring item “app start” is triggered; when the user clicks on a hotel, a monitoring item “click point of interest (poi)” is triggered, and the monitoring item also obtains information of the hotel clicked on; and when the client exits, a monitoring item “app exit” is triggered. The server may determine, by using the real-time data reported by the client, the operation behavior performed by the user on the client in a corresponding time window of the client.

For example, a period for generating the second time window is 30 seconds during running of the client. In a process that the user uses the client, each time a running time length of the client is equal to an integer multiple of 30 seconds, that is, when the second time window is generated, an arbitration point is generated. In this case, the server determines, according to the real-time data stream reported by the client within the time period corresponding to the second time window, the operation behavior performed by the user on the client. For example, an advertisement is displayed in a page of a client 1. After a user A starts the client 1, the server receives the monitoring item “app start” via buried points set by the client.

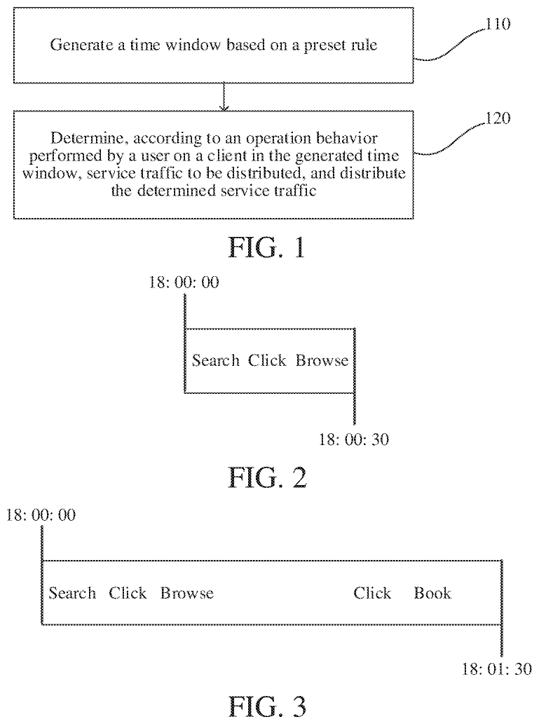

Then, the user A continuously uses the client 1, and performs a series of operations such as searching for hotels, clicking on a hotel list, and browsing hotels by using the client 1. The server receives, by using the buried points set by the client, monitoring items triggered by the operations of the user, and records the monitoring items as the real-time behavior data stream of the user. As the user continuously uses the client, the running time length increases gradually. When the running duration of the client reaches a current period length, for example, 30 seconds, the first second time window is generated, and an arbitration point is generated. The server collects real-time behavior data of the user A within 30 seconds, and determines operation behaviors of the client according to the collected real-time behavior data. If the user A performs operations such as searching for hotels, clicking on a hotel list, and browsing hotels within 30 seconds after the client 1 starts, the server determines operation behaviors of the user A in the first second time window according to the operations performed by the user A within 30 seconds after start of the client 1, including searching, clicking, and browsing in the time window, as shown in FIG. 2. If the user A continuously uses the client 1, and further performs operation such as clicking on a hotel, and booking a hotel room, as the user continuously uses the client, the running time length of the client increases gradually. If the time length increases to an integer multiple of the reference period, for example, 90 seconds, the third arbitration point is generated by generating a second time window. The server collects real-time behavior data of the user A within 90 seconds. As shown in the time window in FIG. 3, the real-time behavior data includes behavior data of searching, clicking, browsing, clicking, and booking operations. The server determines operation behaviors of the user A in the third second time window. Certainly, for different service scenarios, the server may alternatively collect real-time behavior data of the user A within 60 to 90 seconds after the start, and use operations of the collected real-time behavior data as operation behaviors of the user A.

The foregoing describes some manners of “obtaining an operation behavior performed by the user on the client in the generated time window”. The following describes some implementations of “determining, according to the obtained operation behavior, service traffic to be distributed” provided in this embodiment of the present disclosure.

Manner 1: determining intention scores of the user on a plurality of reference service activities according to the operation behavior; and using service traffic corresponding to a reference service activity that has the highest intention score as the service traffic to be distributed.

The intention scores of the user may be determined according to the following manners: matching user actions in the real-time data stream with action sequences configured for reference service activities, to determine a reference service activity matching the user, and then, determining an intention score of the user for the matched reference service activity by using an intention recognition system corresponding to the matched reference service activity; alternatively, determining, by using a reference intention recognition system according to user actions in the real-time data stream, a reference service activity matching the user, and an intention score of the matched reference service activity.

The intention in this embodiment of the present disclosure is used for representing whether the user is interested in a product or project in the client. The intention may be described by using a pre-configured user behavior pattern, or may be described by using an intention score calculated using an algorithm. For example, it is preconfigured that a user behavior pattern of clicking on 3 hotels and performing no purchase within 10 minutes corresponds to an intention, or that an ordering probability recognized by the intention recognition system is a reference value corresponds to an intention. The intention recognition system makes a comprehensive score according to the collected real-time user behavior data of the user, for example, clicking, browsing, collecting, and positioning.

The intention recognition system may offline count preference scores of items, such as a category preference, of the user according to the user data. For example, according to historical purchase and browse behaviors of the user, preference scores (for example, a preference value of crayfish take-away is M, and a preference value of braised chicken is N) of the user for services and categories are calculated offline, and according to at least one of service requirements and the historical behavior data of the user, weights are assigned to user behaviors. For example, a weight of clicking is x, a weight of collecting is y, and a weight of ordering without payment is z. In an actual use process, when making an intention score of the user for a reference service activity, the intention recognition system may calculate an intention score of the behavior of the user within the time period corresponding to the time window with respect to the reference service activity, or a category, or an item according to data such as a dwell time that the user in the client, a geographic location in the real-time data stream, and the behavior of the user.

For example, an operator of the client pre-configures two reference service activities: a service activity 1, configured with an action sequence of a-b-c; and a service activity 2, with a configuration that a score made by an intention recognition system for a takeaway service needs to be higher than p. When a user 12345 uses the client and performs an action sequence of a-b-c, in a time window, the server matches the behavior actions of the user 12345 in this period of time with reference service activities, to obtain the service activity 1. That is, the user 12345 matches the service activity 1. The server invokes the intent recognition system by using the user 12345 and the behavior actions of the user 12345 within the period of time, and obtains that an intention score of a takeaway activity is q, where q>p. That is, the user 12345 also matches the service activity 2. Then, an intention score r of the user 12345 for the service activity 1 is determined by using the intention recognition system. The intention score r of the user 12345 for the service activity 1 is compared with the intention score q for the service activity 2, to obtain a reference service activity that has the highest intention score. In this example, if r<q, it indicates that the service activity 2 has the highest intention score. Therefore, the service activity 2 is used as a target service activity of traffic distribution. That is, the service traffic corresponding to the service activity 2 occupies a channel to perform a reference marketing activity on the user 12345. The server matches the behavior actions of the user 12345 within the period of time with the reference service activities, and may perform action sequence matching in a full-matching manner. In this embodiment of the present disclosure, a, b, and c each represent one behavior action of the user, and x, y, z, m, n, p and q are positive numbers between [0, 1], and are used to measure the size of the intention. Because the user may express a mixed intention in a time window, during intention recognition, a plurality of reference service activities matching the user may be recognized, and by further comparing the intention scores, a service activity that has the highest intention score in the plurality of reference service activities matching the user is selected. The service traffic corresponding to the service activity that has the highest intention score can use the channel to reach the user, thereby improving service traffic utilization.

In addition, whether the intention score is greater than a set value may be further determined, and the intention matching is determined to be successful only when the intention score is greater than the set value. In this case, the determining a reference service activity that has the highest intention score as a target service activity of traffic distribution may include: determining the reference service activity whose intention score is the highest and greater than the preset value, and using the service traffic corresponding to the service activity as the service traffic to be distributed. In this manner, it can avoid distributing service traffic corresponding to a target service activity that has an excessively low intention score.

Then, an implementation of determining, according to the operation behavior performed by the user on the client in the generated time window, the service traffic to be distributed is described by using an example in which the first time window is generated when the client exits. First, when the client exits, the monitoring item “app exit” is triggered. The triggered monitoring item is reported to the backend server. In this case, the first time window is generated, and an arbitration point is generated. The server obtains, within the time period from start of the client to exit of the client, a real-time data stream reported by the client, and determines reference service activities matching the user and intention scores of the reference service activities. Then, according to the intention scores, a service activity matching the user is selected, and marketing reaches the user through a user reach channel.

Manner 2: determining, according to a hit rule of each service activity and obtained operation behaviors, service traffic hit by the operation behaviors, and selecting service traffic corresponding to a service activity that has the highest priority in the hit service activities as the service traffic to be distributed.

The hit rule may be a configuration condition of a service activity. For example, that a user clicks on a takeaway hot pot category more than 3 times may be a configuration condition of a service activity, and is a hit rule of the service activity.

Exemplarily, a priority of each service activity may be preset. When operation behaviors of the user in a time window hit a plurality of service activities, a service activity with the highest priority is selected from the plurality of service activities, and service traffic corresponding to the service activity is used as the service traffic to be distributed.

For manners of distributing the service traffic, reference may be made to technologies well known by a person skilled in the art. In an implementation provided in the present disclosure, when both the first time window and the second time window are generated according to the reference rule, the distributing the determined service traffic may include: distributing, by using an exclusive channel, the service traffic to be distributed that is determined according to the operation behavior performed by the user on the client in the generated first time window; and distributing, by using a non-exclusive channel, the service traffic to be distributed that is determined according to the operation behavior performed by the user on the client in the generated second time window.

The user reach channel is a channel in which the app pushes information to the user, and the information includes at least: a short message, a push, a red packet/voucher, an internal message, an internal-external advertisement, or the like. The short message further includes: a functional short message and a marketing short message, and the marketing short message has a frequency limit. The push further includes: functional information and marketing information, and the marketing information has a frequency limit. A user reach channel with a frequency limit is an exclusive channel, and a user reach channel without a frequency limit is a non-exclusive channel. The exclusive channel generally includes marketing short messages and marketing pushes. To avoid excessive interruptions to the user, there is a strict limit on the number of reaches per day. For example, the user can only receive one marketing short message a day. The non-exclusive channel is generally a user reach channel that can be reused, such as a resource advertisement, an app internal message, a coupon, or the like, and may reach the user for a plurality of times a day.

In the process that the user uses the client, a reference service activity that has the highest intention score is selected as the target service activity of traffic distribution, and is allowed to occupy the non-exclusive channel, to improve the service traffic utilization. After the user exits the client, a reference service activity that has the highest intention score is selected as the target service activity of traffic distribution, and is allowed to occupy the non-exclusive channel, to improve the service traffic utilization.

For manually configured intentions, because of inconsistency in the time scale, a service activity that has a low threshold (for example, just one click) for intention configuration first occupies the user reach channel. In this case, for the exclusive channel (the short message, the push, or the like), activities whose intentions take a long time are unable to use the channel to reach the user. Because of the time scale inconsistency of intention recognition, the intention recognition system cannot intervene in arbitration or select a service activity according to a priority, resulting in improper utilization of the user reach channel.

In the embodiments of the present disclosure, a time window is generated based on a reference rule; and service traffic to be distributed is determined according to an operation behavior performed by a user on a client in the generated time window, and the determined service traffic is distributed. According to the service traffic distribution method provided in the embodiments of the present disclosure, matching degrees of the user behavior with all service activities in the same time period are comprehensively considered, and a service activity that has the highest matching degree is selected to allow marketing to reach the user. From an application level, overall traffic utilization efficiency of an app is comprehensively considered, thereby efficiently improving service traffic distribution efficiency.

When the app is used, a built-in user reach channel of the app may be fully used, and marketing activities are performed on the user, for example, sending an internal message or releasing an internal advertisement to the user. After the user exits the app, a service activity is selected according to a priority to occupy the exclusive channel, and marketing activities are performed on the user. For example, a marketing short message is sent by using a third-party platform. The user reach channel is used properly, to help improve the service traffic distribution efficiency, and improve resource utilization.

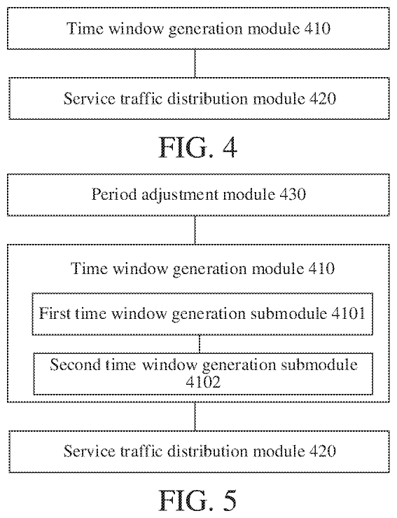

A service traffic distribution apparatus based on a time window disclosed in this embodiment, as shown in FIG. 4, includes:

a time window generation module 410, configured to generate a time window based on a reference rule; and

a service traffic distribution module 420, configured to: determine, according to an operation behavior performed by a user on a client in the generated time window, service traffic to be distributed, and distribute the determined service traffic.

In some embodiments, as shown in FIG. 5, the time window generation module 410 includes:

a first time window generation submodule 4101, configured to generate a first time window when the client exits, where the first time window is a time period from start to exit of the client.

In some embodiments, as shown in FIG. 5, the time window generation module 410 includes:

a second time window generation submodule 4102, configured to generate a second time window according to a period when the client runs, where a start moment of the second time window is a start moment of the period, and an end moment of the second time window is an end moment of the period.

In some embodiments, as shown in FIG. 5, the apparatus further includes:

a period adjustment module 430, configured to adjust duration of the period according to at least one of a behavior habit of the user and a service type of an operation currently performed by the user in the client.

For example, according to historical statistics information, for a user who has a relatively long decision-making period, a longer period is set for the user, for example, 1 minute. Alternatively, a current period is adjusted according to characteristics of a commodity category currently viewed by the user in the client, and the like. For example, a browse for a wedding category takes a longer time than a browse for a takeaway category. In this case, when the user browses commodities of the wedding category, a longer period is set, for example, 5 minutes. When the user switches to browse a food category, a shorter period is set, for example, 30 seconds. By dynamically adjusting the current period, the intention of the user obtained in a decision-making period is as complete as possible, and the number of decision-makings may be reduced, thereby improving service traffic distribution efficiency.

In some embodiments, as shown in FIG. 5, the service traffic distribution module 420 may be further configured to:

determine intention scores of the user on a plurality of reference service activities according to the operation behavior; and use service traffic corresponding to a reference service activity that has the highest intention score as the service traffic to be distributed.

In some embodiments, the using service traffic corresponding to a reference service activity that has the highest intention score as the service traffic to be distributed includes:

using the service traffic corresponding to the reference service activity whose intention score is the highest and greater than a set value as the service traffic to be distributed.

In some embodiments, the distributing the determined service traffic includes:

distributing, by using an exclusive channel, the service traffic to be distributed that is determined according to the operation behavior performed by the user on the client in the generated first time window, where the exclusive channel is a user reach channel with a frequency limit.

In some embodiments, the distributing the determined service traffic includes:

distributing, by using a non-exclusive channel, the service traffic to be distributed that is determined according to the operation behavior performed by the user on the client in the generated second time window, where the non-exclusive channel is a user reach channel without a frequency limit.

This embodiment is an apparatus embodiment corresponding to the method embodiment shown in FIG. 1 to FIG. 3, and implementations of the modules and the submodules of the apparatus are the same as corresponding method steps. Details are not described again in this embodiment.

According to the service traffic distribution apparatus disclosed in the embodiments of the present disclosure, a time window is generated based on a reference rule; and service traffic to be distributed is determined according to an operation behavior performed by a user on a client in the generated time window, and the determined service traffic is distributed. According to the service traffic distribution apparatus provided in the embodiments of the present disclosure, matching degrees of the user behavior with all service activities in the same time period are comprehensively considered, and a service activity that has the highest matching degree is selected to allow marketing to reach the user. From an application level, overall traffic utilization efficiency of an app is comprehensively considered, thereby efficiently improving service traffic distribution efficiency.

During distribution of the service traffic based on the time window, when the user is using the client, matching is performed according to real-time data of the user and reference activities occupying a non-exclusive channel. When the user exits the client, matching is performed according to the real-time data of the user and reference activities occupying an exclusive channel, thereby fully improving utilization of the non-exclusive channel and exclusive channel. In addition, when the app is used, a built-in user reach channel of the app may be fully used, and marketing activities are performed on the user, for example, sending an internal message or releasing an internal advertisement to the user. After the user exits the app, a service activity is selected according to a priority to occupy the exclusive channel, and marketing activities are performed on the user. For example, a marketing short message is sent by using a third-party platform. The user reach channel is used properly, to help improve the service traffic distribution efficiency, and improve resource utilization.

In the related art, in practice, time window management is not used for distributing service traffic. When an intention occurs, matching with service activities begins. It is impossible to predict whether the user may hit another service activity in the future, and estimate, according to a hit probability, a real-time effect of the service activity, and the like, whether to abandon a currently existing hit and wait for another possible hit, or to directly respond to the current hit. Therefore, the service activity matching algorithm in the related art does not accurately predict a trend and a change of the intention in the future. According to the service traffic distribution method provided in the embodiments of the present disclosure, the user may fully express the intention by using the time window, to perform accurate intention recognition and matching with service activities, so as to further improve accuracy of service traffic distribution, thereby effectively improving the service traffic distribution efficiency and the resource utilization.

The service traffic distribution apparatus disclosed in this embodiment of the present disclosure may be configured to implement the service traffic distribution method based on a time window shown in FIG. 1 to FIG. 3. For related concepts and implementations, refer to the descriptions in the method embodiment shown in FIG. 1 to FIG. 3. Details are not described herein again.

Correspondingly, the present disclosure further discloses an electronic device, including a memory, a processor, and a computer program that is stored in the memory and is executable by the processor, the processor, when executing the computer program, implementing the service traffic distribution method based on a time window shown in FIG. 1 to FIG. 3 according to the present disclosure. The electronic device may be a PC, a mobile terminal, a personal digital assistant, a tablet computer, or the like.

The present disclosure further discloses a non-transitory computer-readable storage medium, storing a computer program, the program, when executed by a processor, implementing the service traffic distribution method based on a time window shown in FIG. 1 to FIG. 3 according to the present disclosure.

The embodiments in this specification are all described in a progressive manner. Description of each of the embodiments focuses on differences from other embodiments, and for the same or similar parts among the embodiments, refer to each other. The apparatus embodiment is basically similar to the method embodiment, and therefore is described briefly. For related parts, refer to some descriptions in the method embodiment.

The service traffic distribution method and apparatus based on a time window provided in the present disclosure are described in detail above. The principle and implementations of the present disclosure are described herein by using examples. The descriptions of the foregoing examples are merely used for helping understand the method and core ideas of the present disclosure. In addition, a person of ordinary skilled in the art can make variations in terms of the implementations and application scopes according to the ideas of the present disclosure. In conclusion, the content of this specification shall not be construed as a limitation to the present disclosure.

Through the description of the foregoing implementations, a person skilled in the art may clearly understand that the implementations may be implemented by software in addition to a necessary universal hardware platform, and may certainly be implemented by hardware. Based on such an understanding, the technical solutions essentially or the part contributing to the related art may be implemented in a form of a computer software product. The computer software product may be stored in a non-transitory computer-readable storage medium, such as a ROM/RAM, a magnetic disk, or an optical disc, and includes several instructions for instructing a computer device (which may be a personal computer, a server, a network device, or the like) to perform the methods described in the embodiments or some parts of the embodiments.

1. A service traffic distribution method based on a time window, comprising:
generating a time window based on a reference rule;
determining, according to an operation behavior performed by a user on a client in the generated time window, service traffic to be distributed; and
distributing the determined service traffic.

2. The method according to claim 1, wherein the generating a time window based on a reference rule comprises:
generating a first time window when the client exits, wherein the first time window is a time period from start to exit of the client.

3. The method according to claim 1, wherein the generating a time window based on a reference rule comprises:
generating a second time window according to a period when the client runs, wherein a start moment of the second time window is a start moment of the period, and an end moment of the second time window is an end moment of the period.

4. The method according to claim 3, wherein the method further comprises:
adjusting duration of the period according to at least one of a behavior habit of the user and a service type of an operation currently performed by the user in the client.

5. The method according to claim 1, wherein the determining, according to an operation behavior performed by a user on a client in the generated time window, service traffic to be distributed comprises:
determining intention scores of the user on a plurality of reference service activities according to the operation behavior; and
using service traffic corresponding to a reference service activity that has the highest intention score as the service traffic to be distributed.

6. (canceled)

7. The method according to claim 2, wherein the distributing the determined service traffic comprises:
distributing, by using an exclusive channel, the service traffic to be distributed that is determined according to the operation behavior performed by the user on the client in the generated first time window, wherein the exclusive channel is a user reach channel with a frequency limit.

8. The method according to claim 3, wherein the distributing the determined service traffic comprises:
distributing, by using a non-exclusive channel, the service traffic to be distributed that is determined according to the operation behavior performed by the user on the client in the generated second time window, wherein the non-exclusive channel is a user reach channel without a frequency limit.

9-16. (canceled)

17. An electronic device, comprising a memory, a processor, and a computer program that is stored in the memory and is executable by the processor, the processor, when executing the computer program, implementing a service traffic distribution method based on a time window, the method comprising:
generating a time window based on a reference rule;
determining, according to an operation behavior performed by a user on a client in the generated time window, service traffic to be distributed; and
distributing the determined service traffic.

18. A non-transitory computer-readable storage medium, storing a computer program, the program, when executed by a processor, implementing a service traffic distribution method based on a time window, the method comprising:
generating a time window based on a reference rule;
determining, according to an operation behavior performed by a user on a client in the generated time window, service traffic to be distributed; and
distributing the determined service traffic.

19. An electronic device according to claim 17, wherein the processor, when executing the computer program, implements:
generating a first time window when the client exits, wherein the first time window is a time period from start to exit of the client.

20. The electronic device according to claim 17, wherein the processor, when executing the computer program, implements:
generating a second time window according to a period when the client runs, wherein a start moment of the second time window is a start moment of the period, and an end moment of the second time window is an end moment of the period.

21. The electronic device according to claim 20, wherein the processor, when executing the computer program, implements:
adjusting duration of the period according to at least one of a behavior habit of the user and a service type of an operation currently performed by the user in the client.

22. The electronic device according to claim 17, wherein the processor, when executing the computer program, implements:
determining intention scores of the user on a plurality of reference service activities according to the operation behavior; and
using service traffic corresponding to a reference service activity that has the highest intention score as the service traffic to be distributed.

23. The electronic device according to claim 19, wherein the processor, when executing the computer program, implements:
distributing, by using an exclusive channel, the service traffic to be distributed that is determined according to the operation behavior performed by the user on the client in the generated first time window, wherein the exclusive channel is a user reach channel with a frequency limit.

24. The electronic device according to claim 20, wherein the processor, when executing the computer program, implements:
distributing, by using a non-exclusive channel, the service traffic to be distributed that is determined according to the operation behavior performed by the user on the client in the generated second time window, wherein the non-exclusive channel is a user reach channel without a frequency limit.

25. The non-transitory computer-readable storage medium according to claim 18, wherein the program, when executed by a processor, implements:
generating a first time window when the client exits, wherein the first time window is a time period from start to exit of the client.

26. The non-transitory computer-readable storage medium according to claim 18, wherein the program, when executed by a processor, implements:
generating a second time window according to a period when the client runs, wherein a start moment of the second time window is a start moment of the period, and an end moment of the second time window is an end moment of the period.

27. The non-transitory computer-readable storage medium according to claim 18, wherein the program, when executed by a processor, implements:
determining intention scores of the user on a plurality of reference service activities according to the operation behavior; and
using service traffic corresponding to a reference service activity that has the highest intention score as the service traffic to be distributed.

28. The non-transitory computer-readable storage medium according to claim 25, wherein the program, when executed by a processor, implements:
distributing, by using an exclusive channel, the service traffic to be distributed that is determined according to the operation behavior performed by the user on the client in the generated first time window, wherein the exclusive channel is a user reach channel with a frequency limit.

29. The non-transitory computer-readable storage medium according to claim 26, wherein the program, when executed by a processor, implements:
distributing, by using a non-exclusive channel, the service traffic to be distributed that is determined according to the operation behavior performed by the user on the client in the generated second time window, wherein the non-exclusive channel is a user reach channel without a frequency limit.
